(19) United States
(12) Patent Application Publication
(10) Pub. No.: US 2008/0109624 A1
(43) Pub. Date: May 8, 2008

(54) Multiprocessor system with private memory sections

(76) Inventors: Jeffrey D. Gilbert, Portland, OR (US); Stephen R. Wheat, Gilbert, AZ (US); Kai Cheng, Portland, OR (US); Rajesh S. Pamujula, Hillsboro, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/592,771

(22) Filed: Nov. 3, 2006

(51) Int. Cl. G06F 12/08

(52) U.S. Cl. 711/163; 711/E12.098

(57) ABSTRACT

A system and method for providing multiprocessors with private memory are described. In one embodiment, a first chip couples to a plurality of processor chips. In one embodiment, the first chip includes memory management circuitry and system coherency circuitry. In one embodiment, the memory management circuitry assigns segments of memory to be system memory sections or private memory sections within a segment. In one embodiment, the system coherency circuitry maintains coherence of entries in the system memory.

### TECHNICAL FIELD

Embodiments of the inventions relate to multiprocessor systems with private memory sections.

### BACKGROUND ART

Various arrangements for multiprocessor systems have been proposed. For example, in a front-side bus system, multiple processors communicate data through a bidirectional front-side bus to a chipset that includes a memory controller and memory block. The chipset couples to various other devices such as a display, wireless communication device, hard drive devices (HDD), main memory, clock, input/output (I/O) device and power source (battery). In one embodiment, a chipset is configured to include a memory controller hub (MCH) and/or an I/O controller hub (ICH) to communicate with I/O devices, such as a wireless communication device. The multiple processors have uniform memory access (UMA) to the memory block. In another arrangement, a plurality of processors are coupled to a chipset with a first bus and a different plurality of processors are coupled to the chipset with a second bus. The chipset includes a bridge for communications between the two buses.

Multiprocessor systems can be split into several separate segments. Typically, splitting a multiprocessor system into several smaller segments results in each segment operating at a higher performance level compared to a non-segmented memory system. In a segmented multiprocessor system, fewer agents are required to generate transactions within a segment potentially leading to operating the buses and interconnect of the segment at a higher frequency and lower latency compared to a non-segmented multiprocessor system.

If the segments within a segmented multiprocessor system share a physical address space such as UMA, then coherency operations occur between segments to insure memory consistency. However, these coherency operations can consume substantial system resources that could otherwise be used for performing operations, transactions, and accessing memory. Multiprocessor system performance can be adversely affected based on the overhead of coherency operations within a segmented multiprocessor system.

### BRIEF DESCRIPTION OF THE DRAWINGS

The various embodiments of the present invention are illustrated by way of example, and not by way of limitation, in the figures of the accompanying drawings and in which:

FIG. 1 is a block diagram representation of a multiprocessor system with private memory sections, according to one embodiment.

FIG. 2 is a block diagram representation of a physical address space of a multiprocessor system with system and private memory sections, according to one embodiment.

FIG.3 is a block diagram representation of a multiprocessor system with private memory sections, according to one embodiment.

FIG. 4 is a block diagram representation of a multiprocessor system with private memory sections, according to one embodiment.

FIG. 5 shows a flow chart for a method to access private and system memory sections, according to one embodiment.

FIG. 6 shows a flow chart for a method to access private and system memory sections, according to one embodiment.

FIG. 7 shows a flow chart for a method to access private and system memory sections, according to one embodiment.

FIG. 8 shows a flow chart for a method to access private and system memory sections, according to one embodiment.

### DETAILED DESCRIPTION

A system and method for providing multiprocessors with private memory are described. In one embodiment, a first chip couples to a plurality of processor chips. In one embodiment, the first chip includes memory management circuitry and system coherency circuitry. The memory management circuitry assigns segments of memory to be system memory sections or private memory sections within a segment. The system coherency circuitry maintains coherence of entries in the system memory sections.

In the following description, numerous specific details such as logic implementations, sizes and names of signals and buses, types and interrelationships of system components, and logic partitioning/integration choices are set forth in order to provide a more thorough understanding. It will be appreciated, however, by one skilled in the art that the invention may be practiced without such specific details. In other instances, control structures and gate level circuits have not been shown in detail to avoid obscuring the invention. Those of ordinary skill in the art, with the included descriptions, will be able to implement appropriate logic circuits without undue experimentation.

In the following description, certain terminology is used to describe features of the invention. For example, the term “logic” is representative of hardware and/or software configured to perform one or more functions. For instance, examples of “hardware” include, but are not limited or restricted to, an integrated circuit, a finite state machine or even combinatorial logic. The integrated circuit may take the form of a processor such as a microprocessor, application specific integrated circuit, a digital signal processor, a micro-controller, or the like. An interconnect between chips could be point-to-point or could be in a multi-drop arrangement, or some could be point-to-point while others are a multi-drop arrangement.

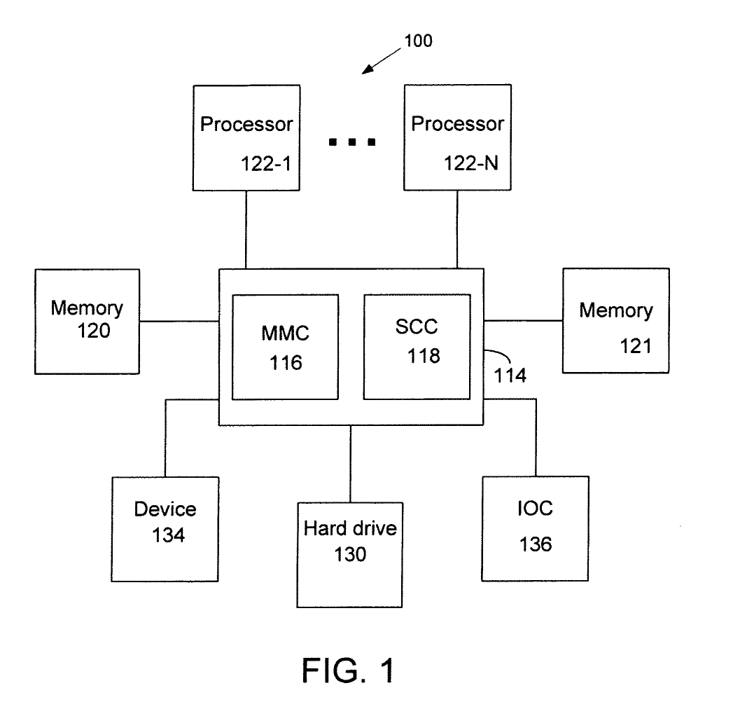

FIG. 1 is a block diagram representation of a multiprocessor system with private memory sections, according to one embodiment. As described herein, a multiprocessor system (MPS) 100 may include, but is not limited to, laptop computers, notebook computers, handheld devices (e.g., personal digital assistants, cell phones, etc.), desktop computers, workstation computers, server computers, computational nodes in distributed computer systems, or other like devices.

Representatively, MPS 100 includes a plurality of processors 122 coupled to a first chip 114. Each processor 122 includes cache memory and may be a processor chip. In one embodiment, a processor system bus (front side bus (FSB)) couples the processors 122 to the chip 114 to communicate information between each processor 122 and the chip 114. In one embodiment, chip 114 is a chipset which is used in a manner to collectively describe the various devices coupled to processors 122 to perform desired system functionality. In one embodiment, chip 114 communicates with device 134, hard drive 130, and I/O controller (IOC) 136. In another embodiment, chip 114 is configured to include a memory controller and/or the IOC 136 in order to communicate with I/O devices, such as device 134 that may include, but is not limited to, a wireless communication device or a network interface controller. In an alternate embodiment, chip 114 is or may be configured to incorporate a graphics controller and operate as a graphics memory controller hub (GMCH). In one embodiment, chip 114 may be incorporated into one of processors 122 to provide a system on a chip.

Chip 114 includes memory 120 and 121, a memory management circuitry (MMC) 116 and system coherency circuitry (SCC) 118. Alternatively, the memory 120 and/or 121 is located external to chip 114. In one embodiment, memory 120 and 121 may include, but is not limited to, random access memory (RAM), dynamic RAM (DRAM), static RAM (SRAM), synchronous DRAM (SDRAM), double data rate (DDR) SDRAM (DDR-SDRAM), Rambus DRAM (RDRAM) or any device capable of supporting high-speed buffering of data. The MMC 116 splits regions of memory into segments with each segment corresponding to at least one processor which is located in close proximity to the memory segment. For example, processors 122-1 and 122-2 may correspond to a segment of memory 120 and processor 122-3 and 122-4 may correspond to a segment of memory 121. These segments can be accessed by the corresponding processor(s) at higher frequencies and lower latencies compared to a non-segmented memory system.

The MMC 116 assigns or alternatively partitions regions of memory within each segment to be system memory or private memory. Memory 120 and 121 may each include multiple regions of system and private memory within each segment. A segment of private memory corresponds to at least one processor having access to the segment of private memory. Other processors have no access to the segment of private memory. In one embodiment, the other processors have limited access to a segment of private memory.

A region of system memory is shared by the processors 122. The system coherency circuitry (SCC) 118 maintains the coherence of entries in the system memory. In one embodiment, the SCC 118 is a snoop filter that is aware of memory in each segment and transmits coherency operations to update necessary segments in memory 120 and 121 as well as maintaining cache memory coherency. The cache memory of each processor can merely be accessed directly by that processor. The SCC 118 is synchronized with memory contents located in various segments.

The SCC 118 can be simplified because the regions of private memory are not accessed from other segments in general. The overhead of the SCC 118 coherence updates for memory lines in private data regions are eliminated for the MPS 100. Typically, many applications may be characterized as a limited number of threads operating on a more or less private data set. In particular, high performance computing applications such as weather forecasting, simulated automobile crashes, nuclear explosions, and video editing are constructed to operate on a private data set. The operation of high performance applications are enhanced because the SCC 118 does not access the regions of private memory. In particular, the latency of communications between the processors 122 and chip 114 are reduced based on the creation of private regions not requiring coherency operations.

The MPS 100 may further include an operating system (OS) which is a software program stored at least partially in the memory 120 and 121. The OS is typically stored in system memory to be shared by the processors 122. The memory management circuitry 116 is controlled at least partially by the OS software. The OS software can be programmed to define the partitioning of the memory segments. The OS software may control fault detection hardware that signals an attempt to reference a private memory section from another segment.

In one embodiment, virtual machines exist in isolated memory regions. For example, a first thread may correspond to a first virtual machine running the OS in a first segment. A second thread may correspond to a second virtual machine running a similar or different OS in a second segment. A virtual machine may perform optimally with segment affinity between a memory segment and processor located in close proximity to the same segment. A virtual machine manager that manages virtual machines maintains coherency of system memory for the virtual machines. Improved virtual machine performance results from having multiple segments to improve segment affinity as well as merely having to maintain coherency between system memory without maintaining coherency of private memory located in different segments.

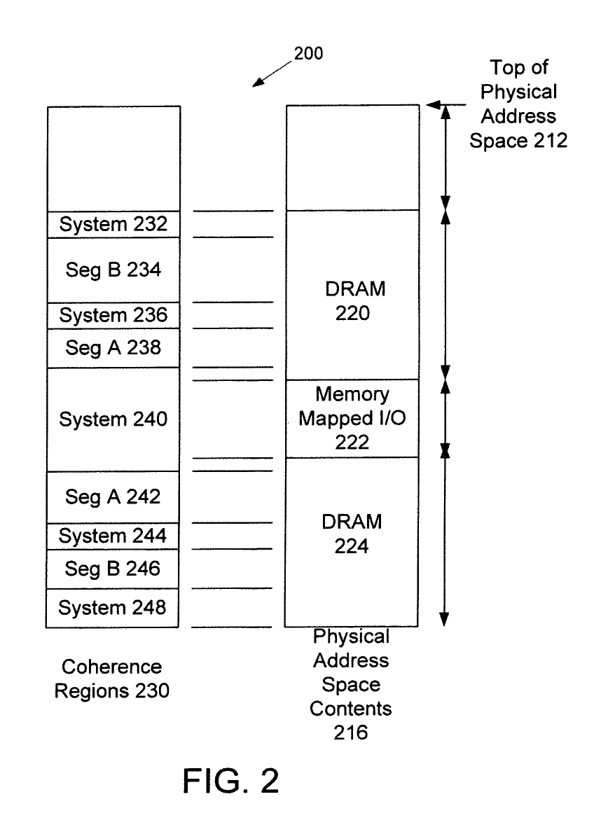

FIG. 2 is a block diagram representation of a physical address space of a multiprocessor system with system and private memory sections, according to one embodiment. In one embodiment, the physical address space (PAS) 200 may include memory 120 or memory 121 as illustrated in FIG. 1. The PAS 200 includes an address range of memory lines which are represented by a physical address space contents 216. The PAS 200 can be partitioned in various arrangements. In one embodiment, the PAS 200 includes a top of physical address space 212, dynamic random access memory (DRAM) 220, a memory mapped input/output (I/O) 222, and a DRAM 224. The DRAM 220 is located above the memory mapped I/O 222 while the DRAM 224 is located below the memory mapped I/O 222 in terms of memory address. The memory mapped I/O 222 may be located immediately below a 4 gigabyte boundary separating the DRAM 220 from the DRAM 224.

The PAS 200 can be partitioned into private and system memory sections or coherence regions 230 using address range descriptions. Private memory sections include segments A and B such as segments 234, 238, 242, and 246. A private memory section can typically be accessed by logic local to a particular segment such as a local processor that has been assigned to the particular segment by the memory management circuitry 116. The SCC 118 is not burdened with coherency operations between private memory sections located in different segments. However, local coherency is maintained for private memory sections located within the same segment.

In one embodiment, the IOC 136 sends a new I/O request to the MMC 116 to determine the location to send the I/O request and if the I/O request needs access to a private memory section. If the I/O request needs access to a private memory section, the MMC 116 checks the cache memory of a corresponding local processor assigned to the private memory section prior to checking the more distant local memory such as memory 120. The local processor or cache agent determines if the content or data of the I/O request is stored in cache memory which results in a cache hit or miss. The local memory is accessed if a cache miss occurs. The local processor maintains local coherency between the local memory and corresponding cache memory. The IOC 136 may access the MMC 116 in order to be aware of the various allocations of memory to ensure that I/O requests accessing private memory are sent to the appropriate private regions and I/O requests accessing system memory utilize the normal coherence mechanism. In another embodiment, the IOC 136 without accessing the MMC 116 ensures that I/O requests accessing private memory are sent to the appropriate private regions and I/O requests accessing system memory utilize the normal coherence mechanism.

System memory sections include system sections 232, 236, 240, 244, and 248. System memory sections can be accessed directly or indirectly by any logic such as any processor 122. SCC 118 operations are necessary to maintain coherency between system memory sections. For example, if a new request is written into system memory section 232, the SCC 118 transmits coherency operations to the processors 122 in order to maintain coherency among system memory sections that may be held in processor caches. The coherency operations performed by the SCC 118 may be an adjunct to normal operations. Alternatively, the coherency operations may be dedicated operations in addition to normal operations.

The SCC 118 which may be a snoop filter can be simplified because the regions of private memory sections are not accessed from other segments. The overhead of SCC 118 or snoop filter updates for memory lines in private data regions are eliminated for the MPS 100.

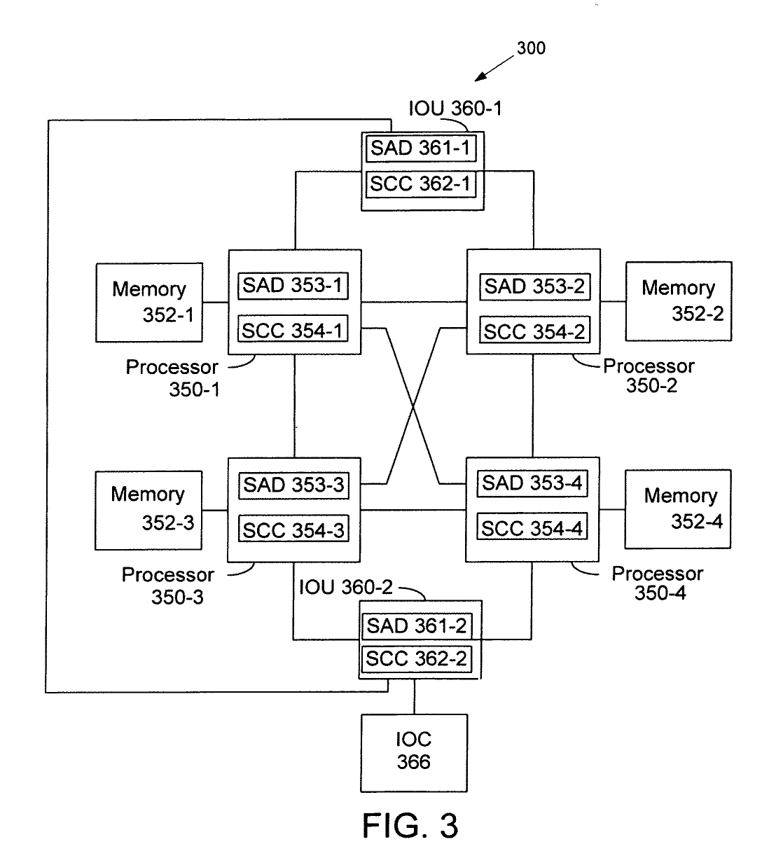

FIG. 3 is a block diagram representation of a multiprocessor system with private memory sections, according to one embodiment. The multiprocessor system (MPS) 300 includes processors 350-1, 350-2, 350-3, and 350-4 with corresponding memory 352-1, 352-2, 352-3, and 352-4 and also cache memory (not shown) internal to each processor. The cache memory is local to each processor and may be accessed significantly faster than the memory 352-1, 352-2, 352-3, and 352-4. The processors are fully connected to each other and communicate with a point to point interconnect protocol such as dedicated high speed interconnects. The MPS 300 further includes input/output units (IOU) 360-1 and 360-2 which are coupled both to processors 350-1, 350-2, 350-3, and 350-4 and to general purpose high speed input/output buses (not shown). The MPS 300 additionally includes an input/output controller (IOC) 366. The IOC 366 sends and receives communications to and from input/output devices included in the IOC 366 and coupled to the IOC 366 through general purpose input/output buses. Input/output devices (not shown) coupled to IOC 366 may include a mouse, keyboard, wireless communication device, speech recognition device, etc. In one embodiment, the functionality of the IOU 360-1 and 360-2 may be combined with IOC 366.

The processors 350-1, 350-2, 350-3, and 3504 each include a corresponding first logic unit and a corresponding second logic unit. In one embodiment, the first logic unit is a system address decoder (SAD) 353-1, 353-2, 353-3, and 353-4 and the second logic unit is a system coherence circuitry (SCC) 354-1, 354-2, 354-3, and 354-4. The IOU 360-1 and the IOU 360-2 also include a corresponding SAD 361-1 and 361-2 and a corresponding SCC 362-1 and 362-2. Each SAD includes a table of memory addresses with the memory addresses split into segments with each segment corresponding to at least one processor. For example, processor 350-1 may be the local processor assigned to memory 352-1 which represents a first segment. Processor 350-2 may be the local processor assigned to memory 352-2 which represents a second segment.

In one embodiment, the SADs collectively assign regions of memory within each segment to be system or private memory using address range descriptions as shown in FIG. 2. The IOUs 360-1 and 360-2 are aware of the various allocations of memory to ensure that I/O accesses to private memory sections are sent to the appropriate private regions and I/O accesses to system regions utilize the normal coherence mechanism.

In another embodiment, each SAD within the processors further assigns regions of memory within each segment to be system or private memory using address range descriptions. The SADs in the IOU 360-1 and 360-2 do not assign regions of system and private memory. The processor assigned to a segment determines whether an I/O request needs to access private or system memory.

Processor 350-1 can access cache memory and also private and system memory located in memory 352-1 which represents segment 1. Processor 350-1 can merely access system memory in the other segments via processors local to each segment, such as memory 352-2, 352-3, and 352-4. Processor 350-1 has limited or possibly no access to private memory in the other segments, such as memory 352-2, 352-3, and 3524.

A region of system memory is shared by the processors 350-1, 350-2, 350-3, and 350-4. Each SCC maintains the coherence of entries for the system memory. In one embodiment, each SCC is aware of memory in each segment and transmits coherency operations to update necessary segments of memory 352-1, 352-2, 352-3, 352-4 and cache memory as well. Each SCC is synchronized with the corresponding cache memory contents. Certain operations of each SCC are an adjunct to normal computing operations. Other operations such as updates may require a dedicated operation. For example, an SCC may have a limited queue size that stores recent cache line requests. In order for the SCC to store a new cache line request, an older cache line request may have to be deleted or evicted from the SCC which then back invalidates the same older cache line request from the cache memory of the corresponding processor.

Each SCC does not maintain coherency for private memory sections located in either cache memory or memory 352-1, 352-2, 352-3, 352-4. The overhead of SCC updates such as back invalidate operations is eliminated. These private memory sections do not need to be accessed by other segments. Thus, maintaining coherency of the private memory sections is unnecessary.

In one embodiment, the IOU 360-2 receives an I/O request from the IOC 366. The IOU 360-2 determines the location to send the I/O request using the SAD 361-2. The IOU 360-1 sends the I/O request to the local processor having the memory to be accessed. For example, processor 350-3 may receive the I/O request from IOU 360-2. The processor 350-3 determines whether the I/O request needs to access private or system memory. If the I/O request needs to access private memory, the processor 350-3 checks its cache memory for the content or data being requested by the I/O request. If a cache hit occurs, then the I/O request accesses the appropriate cache memory line. If a cache miss occurs, then the processor 350-3 sends the I/O request to the appropriate private memory section within the more remote memory 352-3. Coherency operations are not needed for regions of private memory located on different segments.

If the I/O request needs to access system memory, then the SCC 354-3 implements coherency transactions by checking cache memory of the various processors with a broadcast of the I/O request. If a cache hit occurs, then the I/O request accesses the appropriate cache memory line. If a cache miss occurs, the I/O request accesses a more remote memory location such as memory 352-1, 352-2, 352-3, or 352-4. The SCC 354-3 will broadcast to other SCCs in order to obtain the most recent version of the memory to be read.

The SCC typically manages inter bus or interconnect coherence associated with a data transfer such as read or write request. Each SCC can be simplified because the regions of private memory are not accessed from other segments. The overhead of SCC coherency updates for memory lines in private data regions are eliminated for the MPS 300. The number of interconnect coherency transactions are reduced based on having both system and private memory sections with the coherency not being maintained between private memory sections located in different segments.

The operation of high performance applications are enhanced because the SCC does not access the regions of private memory. Coherency is not required and not maintained between regions of private memory. The latency of communications between the processors, between processors and corresponding memory, and also between processors and IOUs are reduced based on the creation of private regions not requiring coherency operations. Buses and interconnect coupling the components or logic of FIG. 3 can be used for normal computing operations and/or transactions rather than overhead such as coherency memory maintenance.

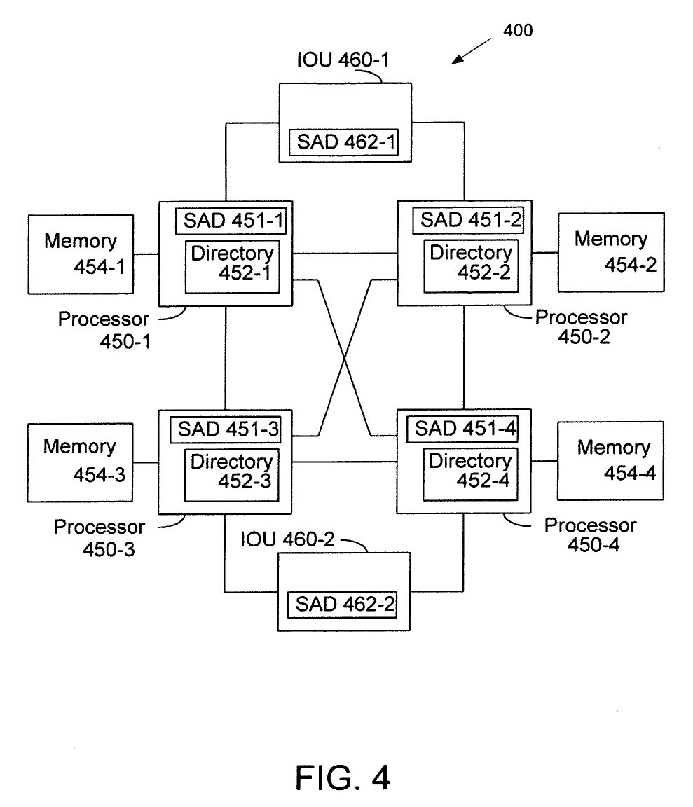

FIG. 4 is a block diagram representation of a multiprocessor system with private memory sections, according to one embodiment. The multiprocessor system (MPS) 400 includes processors 450-1, 450-2, 450-3, and 4504 with corresponding memory 454-1, 454-2, 454-3, and 454-4. The processors 450-1, 450-2, 450-3, and 450-4 each include cache memory (not shown) located in close proximity to each processor. The cache memory is local to each processor and may be accessed significantly faster than the memory 454-1, 454-2, 454-3, and 454-4. The processors are fully connected to each other and communicate with a point to point protocol such as dedicated high speed interconnects. The MPS 400 further includes input/output units (IOU) 460-1 and 460-2 which are coupled to processors 450-1, 450-2, 450-3, and 450-4. The IOU 460-1 and 460-2 send communications to input/output devices and also receives communications from the input/output devices (not shown) which may include a mouse, keyboard, wireless communication device, speech recognition device, etc. The IOU 460-1 and 460-2 include system address decoders (SAD) 462-1 and 462-2 for determining the appropriate location such as a processor to send an I/O request. In one embodiment, the functionality of each IOU is included within an input output controller (not shown).

The processors 450-1, 450-2, 450-3, and 450-4 each include a corresponding first logic unit and a corresponding second logic unit. In one embodiment, the first logic unit is a system address decoder (SAD) 451-1, 451-2, 451-3, and 451-4 and the second logic unit is a directory 452-1, 452-2, 452-3, and 452-4. Each SAD may include a table of memory addresses with the memory addresses split into segments with each segment corresponding to at least one processor. For example, processor 450-1 may be the local processor assigned to memory 454-1 which represents a first segment. Processor 450-2 may be the local processor assigned to memory 454-2 which represents a second segment.

Each SAD may further split regions of memory within each segment to be system or private memory using address range descriptions as shown in FIG. 2. Processor 450-1 can access cache memory and also private and system memory located in memory 454-1 which represents segment 1. Processor 450-1 can merely access system memory in the other segments via processors local to each segment, such as memory 454-2, 454-3, and 454-4. Processor 450-1 can not access or has limited access to private memory in the other segments, such as memory 454-2, 454-3, and 454-4.

A region of system memory is shared by the processors 450-1, 450-2, 450-3, and 4504. Each directory maintains the coherence of entries for the system memory. In one embodiment, each directory is aware of memory in each segment and transmits coherency operations to update necessary segments of memory 454-1, 454-2, 454-3, 4544 and cache memory as well. Each directory may include a snoop filter that is synchronized with the corresponding cache memory contents. Certain operations of each snoop filter are an adjunct to normal computing operations. Other operations such as updates may require a dedicated operation. For example, a snoop filter may have a limited queue size that stores recent cache line requests. In order for the snoop filter to store a new cache line request, an older cache line request may have to be deleted or evicted from the snoop filter which then back invalidates the same older cache line request from the cache memory of the corresponding processor. Among request accessing system memory, merely half of the transactions are transferring data and the other half may be removing older requests.

Each directory does not maintain coherency for private memory sections located in either cache memory or memory 454-1, 454-2, 454-3, and 4544. The overhead of snoop filter updates such as back invalidate operations is eliminated for private memory sections. These private memory sections do not need to be accessed by other segments. Thus, maintaining coherency of the private memory sections is unnecessary.

In one embodiment, MPS 400 implements a two hop communication protocol. For example, IOU 460-1 may receive an I/O request from an I/O device having no knowledge of the partitioning of private and system memory sections. The SAD 462-1 determines that the I/O request needs to access processor 450-3. IOU 460-1 sends the I/O request to processor 450-3, the local processor for the I/O request, via processor 450-1. The local processor 450-3 determines if the memory being accessed is private or system. If private memory is being accessed, then the I/O request accesses local cache memory or memory 454-3. The processor 450-3 maintains local coherency between memory 454-3 and its local cache memory.

If system memory is being accessed, then the local directory 452-3 may check its directory for an updated cache line having the content or data being requested by the I/O request. The I/O request accesses the appropriate cache line if found in the directory. Otherwise, the I/O request accesses the appropriate system section in memory 454-3 in a slower manner compared to accessing cache memory.

The directory or a snoop filter within the directory typically manages inter bus coherence associated with a data transfer such as read or write request. Each directory can be simplified because the regions of private memory are not accessed from other segments. The overhead of directory updates for memory lines in private data regions are eliminated for the MPS 400.

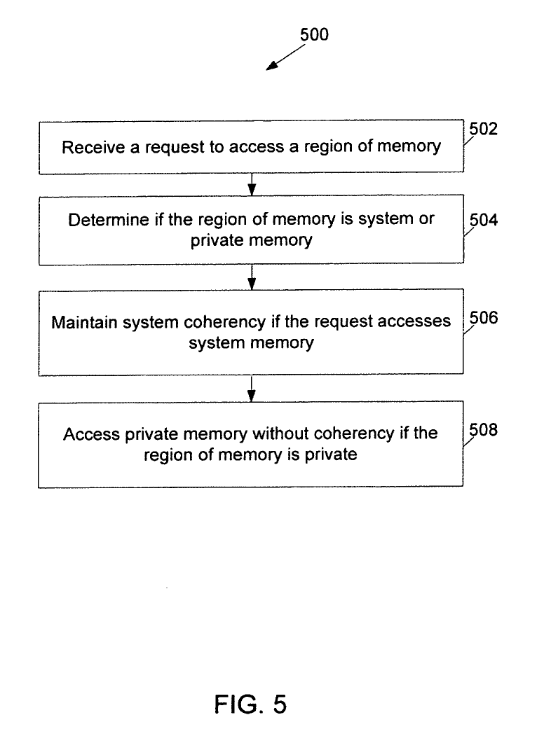

FIG. 5 shows a flow chart for a method to access private and system memory sections, according to one embodiment. The method 500 includes receiving a request to access a region of memory at block 502. The method 500 further includes determining if the region of memory is system or private memory at block 504. The method 500 further includes maintaining system coherency if the request accesses system memory at block 506. No coherency transactions are needed if the request accesses private memory at block 508. An address range descriptor may be assigned to each region of memory. The address range descriptors include system or private memory descriptions that are used at block 504 in determining whether the region of memory is private or system. Improved computing performance results from the method 500 that accesses private and system memory sections without maintaining private coherency because the private coherency operations are eliminated. System coherency operations for regions of system memory are still performed.

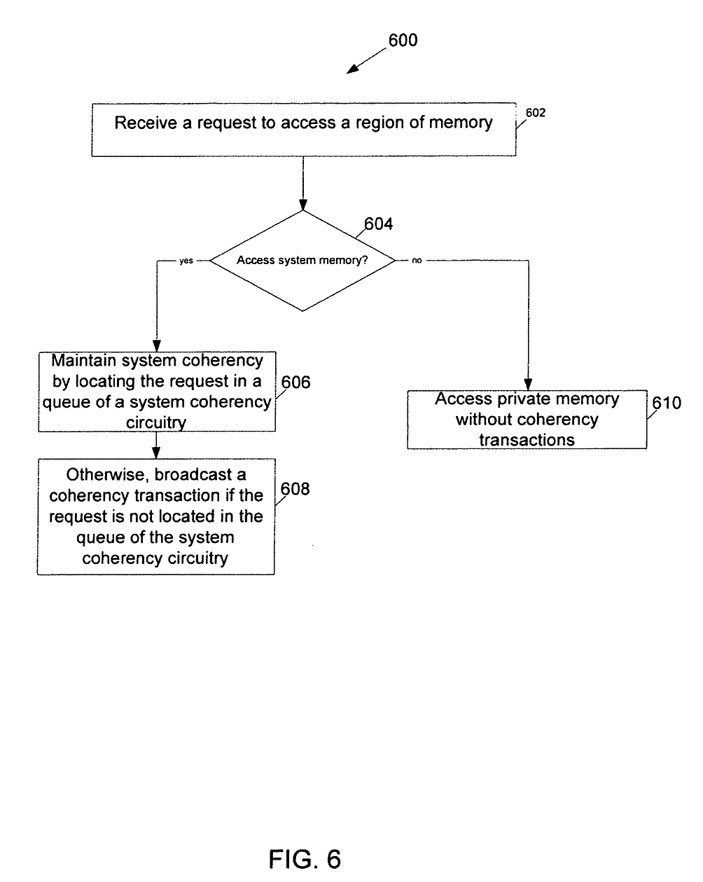

FIG. 6 shows a flow chart for a method to access private and system memory sections, according to one embodiment. The method 600 includes receiving a request to access a region of memory at block 602. The method 600 further includes determining if the region of memory to be accessed is system or private memory at block 604. The method 600 further includes maintaining system coherency if the request accesses system memory at block 606 by locating the request in a queue of a system coherency circuit as illustrated in FIG. 1. The request is sent to the memory address corresponding to the request. Otherwise, the method 600 further includes broadcasting the request to other logic in order to locate the memory address that needs to be accessed by the request at block 608. No coherency transactions are needed if the request accesses private memory at block 610. An address range descriptor may be assigned to each region of memory. The address range descriptors include system or private memory descriptions.

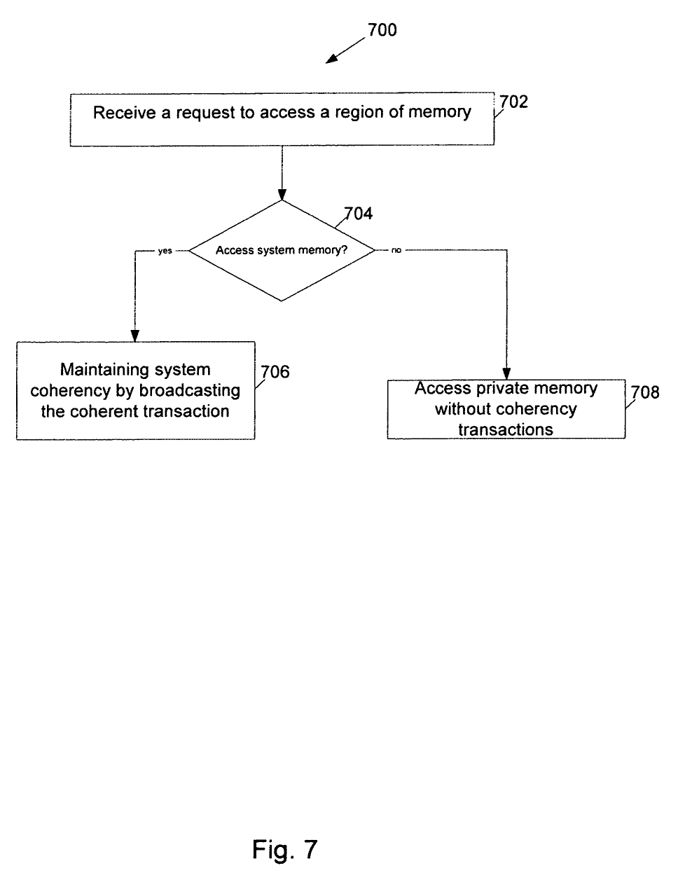

FIG. 7 shows a flow chart for a method to access private and system memory sections, according to one embodiment. The method 700 includes receiving a request to access a region of memory at block 702. The method 700 further includes determining if the region of memory is system or private memory at block 704. The method 700 further includes maintaining system coherency by broadcasting the coherent transaction in order to get the most recent version of the system memory to be accessed at block 706. No coherency transactions are needed if the request accesses private memory at block 708. An address range descriptor may be assigned to each region of memory. The address range descriptors include system or private memory descriptions. The method 700 maintains system coherency for regions of system memory without having to maintain coherency for regions of private memory.

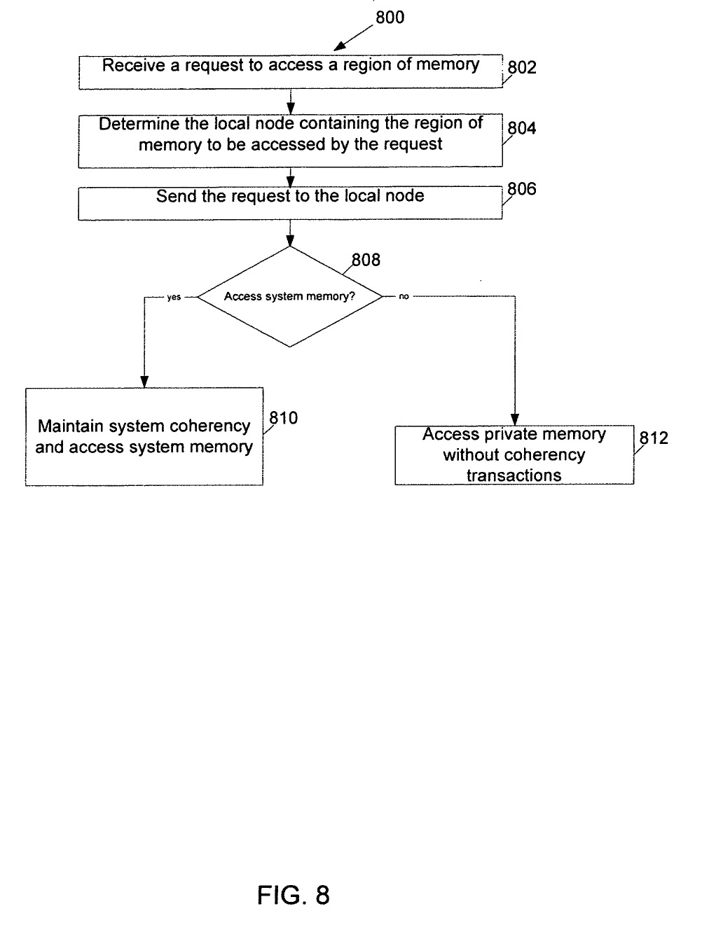

FIG. 8 shows a flow chart for a method to access private and system memory sections, according to one embodiment. The method 800 includes receiving a request to access a region of memory at block 802. The method 800 further includes determining the local node containing the memory to be accessed by the request at block 804. Next, the request is sent to the local node at block 806. A directory located at the local node, as illustrated in FIG. 4, determines if the region of memory to be accessed is system or private memory at block 808. If a private region is being accessed, the directory sends the request to the private region of memory at block 812 without maintaining coherency. If a system region is being accessed, the directory performs coherency operations prior to sending the request to the system region of memory at block 810. The directory may include a snoop filter that checks its queue for the request prior to snooping other logic. The directory or a snoop filter within the directory typically manages inter bus coherence associated with a data transfer such as read or write request. Each directory and method 800 can be simplified because the regions of private memory are not accessed from other segments. The overhead of directory updates for memory lines in private data regions are eliminated for the method 800.

Elements of embodiments of the present invention may also be provided as a machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments described may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments.

In the above detailed description of various embodiments, reference is made to the accompanying drawings, which form a part hereof, and in which are shown by way of illustration, and not of limitation, specific embodiments in which the invention may be practiced. In the drawings, like numerals describe substantially similar components throughout the several views. The embodiments illustrated are described in sufficient detail to enable those skilled in to the art to practice the teachings disclosed herein. Other embodiments may be utilized and derived there from, such that structural and logical substitutions and changes may be made without departing from the scope of this disclosure. The following detailed description, therefore, is not to be taken in a limiting sense, and the scope of various embodiments is defined only by the appended claims, along with the full range of equivalents to which such claims are entitled.

While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components. The hardware logic may consist of electronic circuits that follow the rules of Boolean Logic, software that contain patterns of instructions, or any combination of both. The invention is to be understood as not limited by the specific embodiments described herein, but only by scope of the appended claims.

What is claimed is:

1. An apparatus, comprising:
memory management circuitry to assign segments of memory to be at least one of a system memory section or a private memory section within a segment; and
system coherency circuitry to maintain coherence of entries in the system memory sections.

2. The apparatus of claim 1, wherein local coherence is maintained for private memory sections within the same segment.

3. The apparatus of claim 1, wherein no coherence is maintained between private memory sections in different segments.

4. The apparatus of claim 1, wherein the system coherency circuitry comprises a snoop filter.

5. The apparatus of claim 4, wherein the snoop filter sends coherency operations to segments with system memory sections.

6. A system, comprising:
a first chip couples to a plurality of processor chips;
the first chip comprises
memory management circuitry to assign segments of memory to be at least one of a system memory section or a private memory section within a segment; and
system coherency circuitry to maintain coherence of entries in the system memory sections.

7. The system of claim 6, wherein the memory management circuitry to split regions of memory into isolated segments of memory.

8. The system of claim 6, wherein local coherence is maintained for private memory sections within the same segment.

9. The system of claim 6, wherein no coherence is maintained between private memory sections in different segments.

10. The system of claim 6, further comprising an input/output (I/O) controller coupled to the first chip, wherein the I/O controller to ensure that I/O requests accessing private memory are sent to the appropriate private memory sections and I/O requests accessing system memory utilize the normal coherence mechanism.

11. The system of claim 10, wherein the I/O controller accesses the first chip to ensure that I/O requests accessing private memory are sent to the appropriate private memory sections and I/O requests accessing system memory utilize the normal coherence mechanism.

12. The system of claim 6, wherein the system coherency circuitry to send coherency operations to segments with system memory sections.

13. The system of claim 6, wherein a segment of private memory corresponds to at least one local processor chip having access to the segment of private memory with the other non-local processor chips having no access to the segment of private memory.

14. The system of claim 6, further comprising an operating system stored at least partially in the memory, wherein the memory management circuitry is controlled at least partially by the operating system.

15. A system, comprising:
a plurality of chips coupled to each other with each chip having a processor coupled to memory; and
at least one input output (I/O) unit couples to the plurality of chips, wherein each chip comprises
a first logic unit to assign segments of memory to be at least one of a system memory section or a private memory section within a segment; and
a second logic unit to maintain coherence of entries in the system memory.

16. The system of claim 15, wherein local coherence is maintained for private memory sections within the same segment.

17. The system of claim 15, wherein no coherence is maintained between private memory sections in different segments.

18. The system of claim 15, wherein the first logic unit is a system address decoder and the second logic unit is a system coherency circuitry.

19. The system of claim 18, wherein at least one I/O unit comprises the first logic unit and the second logic unit.

20. The system of claim 15, wherein the second logic unit is a directory.

21. The system of claim 15, wherein a segment of private memory corresponds to at least one local processor chip having access to the segment of private memory with the other non-local processor chips having no access to the segment of private memory.

22. A method comprising:
receiving a request to access a region of memory;
determining if the region of memory is system or private memory;
maintaining system coherency if the request accesses system memory; and
accessing private memory without coherency if the region of memory is private.

23. The method of claim 22, further comprising assigning an address range descriptor to each region of memory, wherein the address range descriptors comprise system and private memory descriptions.

24. The method of claim 22, wherein maintaining system coherency further comprises:
sending the request to a memory address corresponding to the request if the request is located in a queue of a system coherency circuitry; and
broadcasting a coherency transaction if the request is not located in the queue of the system coherency circuitry.

25. The method of claim 22, wherein maintaining system coherency further comprises:
broadcasting a coherency transaction to receive an updated region of memory corresponding to the request.

26. The method of claim 22, further comprising:
determining the local node for the request;
sending the request to the local node; and
wherein maintaining system coherency if the request accessing system memory occurs with a directory located in the local node.

27. A machine-readable medium having stored thereon instructions, which, when executed, performs the method of claim 22.

28. A machine-readable medium having stored thereon instructions, which, when executed, performs the method of claim 24.

29. A machine-readable medium having stored thereon instructions, which, when executed, performs the method of claim 26.
